(19) United States
(12) Patent Application Publication
(10) Pub. No.: US 2016/0350677 A1
(43) Pub. Date: Dec. 1, 2016

(54) System and Method for Generating and Issuing Proofs of Enrollment

(71) Applicants: Prakash A. PATHAK, Avondale, PA (US); Elizabeth Lozanoff, Deptford, NJ (US); James R. Saltysiak, Oxford, PA (US)

(72) Inventors: Prakash A. PATHAK, Avondale, PA (US); Elizabeth Lozanoff, Deptford, NJ (US); James R. Saltysiak, Oxford, PA (US)

(73) Assignee: JPMORGAN CHASE BANK, N.A., New York, NY (US)

(21) Appl. No.: 12/372,400

(22) Filed: Feb. 17, 2009

(51) Int. Cl. G06Q 50/00; G06Q 30/00; G06Q 40/00; G06Q 99/00

(52) U.S. Cl. CPC G06Q 5/20

(57) ABSTRACT

A system and method for issuing an obvious and indisputable proof of enrollment corresponding to at least one program or service a user agrees to enroll in or receive. The method comprising the steps of: offering a user at least one program or service and an incentive for enrolling in or receiving the program or service. Next, the user is presented with a task or action the user is required to perform in or accept the at least one program or, service. Then, input signals are received indicating the user's performance of the required task or action, wherein the input signals received confirm the user's agreement to enroll in or receive the at least one program or service. The user is then provided with an incentive or value for performing the required task or action. Finally, an obvious and indisputable proof of enrollment or acceptance record is generated and issued indicating that the user has elected to enroll in or receive the at least one program, service or value.

### FIELD OF THE INVENTION

The present invention relates to systems and methods for providing offers to users and permitting the user to accept the offer by performing a certain task or action. More particularly, the present invention relates to systems and methods for offering an incentive or reward to a user in exchange for the user enrolling in a program or service, wherein enrollment is accomplished by the user performing a certain task or action.

### BACKGROUND

Financial transactions are increasingly being conducted and processed using transaction cards and other devices. As those transactions increase, financial institutions have taken to offering its customers programs and services that enhance the functionality and reliability of such cards and devices. For example, many banks and other financial institutions offer loyalty or reward programs, as well as fraud or payment protection programs that a customer may enroll in to guard against excessive spending or fraudulent or improper use of the card or device by another. Other types of programs and services are commonly offered.

In many cases, enrollment in these programs and services is voluntary and requires the customer to request, approve or confirm enrollment and pay an associated fee or other service charge that typically is incurred on a monthly or other periodic basis. The bank or financial institution offers these programs and services to its customers in several different ways. One approach is for a live agent or an interactive voice response (IVR) system to offer the customer the opportunity to enroll in a program or service during activation of an account or transaction card or device. For example, when a customer calls to activate a transaction card or device (e.g., a credit, debit), a representative or IVR of the financial institution may ask the customer if he or she would like to enroll in a program or service associated with a transaction card or device. If the customer responds in the affirmative, the agent may then enroll the customer in the respective program or service. Another approach is for a financial institution to mail the program or service offers directly to its customers, and subsequently initiate enrollment upon certain behavior or action by the customer. For example, a financial institution may solicit enrollment by sending a customer a “check” or other incentive for a predetermined amount of value. Along with the check, the customer is presented with an offer to enroll in a program or service simply by cashing the check for value. Thus, by cashing the check the customer is deemed to have accepted the offer and is thereby automatically enrolled in the particular program or service.

While the above and other known systems and methods have been effective in enrolling customers in various programs and services offered by financial institutions, they nonetheless suffer from several notable drawbacks. First, current systems and methods do not have a reliable or effective way to confirm and maintain a customer's acknowledgement of enrollment in programs or services in an obvious, indisputable and undeniable manner. In other words, current systems and methods do not maintain indisputable and undeniable records of a customer's approval to be enrolled in or to receive a particular program or service. As a result, many customers subsequently cancel their enrollment claiming they were not aware that they were being enrolled or that they would be obligated to make ongoing periodic payments for the program or service. Second, current systems and methods do not provide the customer the offered incentive or reward immediately upon performing the action or task required to enroll in or receive the offered program or service. For example, customer's are not able to immediately realize the benefit of the “check” because the customer must first cash the check in order to be able to use it.

In short, while it is known that a customer may selectively opt-in to a particular program or service being offered by a bank (e.g., by cashing a check or activating an account or transaction card or device via a live agent or IVR and thereby enroll in a select program or service associated with an account or transaction card or device), there is no known system or method which: (1) enrolls the user in or provides the user with a program or service upon the user performing a certain task or action, (2) immediately provides the customer with an incentive or value in exchange for enrolling in or receiving the program or service, and (3) generates a unique, storable, obvious and indisputable proof of enrollment upon the customer's performance of the task or action, which proof of enrollment undeniably confirms the user's agreement to enroll in or receive the program or service.

### SUMMARY OF THE INVENTION

According to various embodiments, the systems and methods described herein relate to, among other things, systems and methods which: (1) enroll the user in or provide the user with a program or service upon the user performing a certain task or action, (2) immediately provide the customer with an incentive or value in exchange for enrolling in or receiving the program or service, and (3) generate a unique, storable, obvious and indisputable proof of enrollment upon the customer's performance of the task or action, which proof of enrollment undeniably confirms the user's agreement to enroll in or receive the program or service.

The product or service offered to a customer may comprise, for example, a payment protection program, a fraud protection program, or other program, service, feature or functionality that may be associated with an account or transaction card or device. In some embodiments, the action or behavior required of the customer in order to enroll in or receive the product or service may comprise viewing or participating in a presentation or demonstration (e.g., watching a marketing demonstration or video), making a certain purchase or transaction, activating a transaction card or device, upgrading to a new or different transaction card or device, opting-in to a program or service, approving a certain action or charge, taking a survey, using a new program or service, retaining a certain program, service, card or device, increasing engagement or spending, or any other action or behavior that may confirm or acknowledge the customer's agreement to enroll in or receive the program or service. The incentives or rewards that may be offered to the customer in exchange for enrolling in or agreeing to receive a program or service may include issuing or reloading an account or credit, debit, stored value card or other transaction device to the customer, issuing credit or other value to a customer's savings or checking account, increasing the credit limit associated with the customer's credit card, rewarding reward points or other value (e.g., airline miles or points), or other form of incentive or reward.

As an example of the above concept, a financial institution may be introducing a new credit card program (e.g., a credit or fraud protection program) and is seeking to increase customer interest and enrollment in the new program. In order to enroll in the program, a customer may be required to view a video demonstration or presentation which describes the program and its benefits. The video or program may be presented to the customer via a web site accessible by the customer. In order to entice the customers to view the demonstration and thereby enroll in the program, the financial institution may also offer any number of incentives or rewards. For example, the customer may be offered a stored value card of a certain amount that may be used to make purchases and enter into other transactions. The customer may also be offered an increased credit limit on the credit card to which the new program is to be applied. Other rewards are of course possible.

In some embodiments, the video demonstration may be interactive. For example, while viewing the presentation, the customer may be presented with certain queries or questions the answers to which may be used to confirm user acknowledgement or agreement to enroll in or receive the program. For example, upon being presented the details and benefits of the program, the customer may be expressly asked whether the customer would like to enroll in the program. The user's answer to these queries may then be used to confirm the user's agreement to enroll. The user's participation in the view demonstration and acknowledgement to enroll in the program may then result in the generation and issuance of an obvious and indisputable proof of enrollment, and the issuance of the particular incentive or reward offered to the customer in exchange for enrolling in the program.

In another example, the customer may comprise a cardholder that has experienced financial problems or set-backs. The systems or methods described herein may offer the customer the opportunity to lower his monthly payment (or reduce his interest rate), for example, if the customer agrees to view an educational video presentation that informs the customer on best practices for reestablishing or maintaining good credit. The customer may also be required to enroll in a credit protection program, for example, which the customer can effectively do by viewing the education video program. Once confirmation is obtained that the user desires to enroll in the credit protection program (e.g., by receiving user responses to queries), an obvious and indisputable proof of enrollment may be generated and issued, and the appropriate incentive or reward (e.g., lower monthly payment or interest rate) is provided to the customer. Other examples of requiring defined user tasks or actions to confirm user enrollment in a program or service are of course possible.

The proof of enrollment generated by the systems and methods described herein serves to reliably confirm a customer's agreement to enroll in a program or service, and thereby helps guard against subsequent claims by the customer that he or she did not intend to enroll or was unaware that he or she had enrolled in or agreed to receive. In some embodiments, a proof of enrollment may correspond to or be associated with a particular customer, and/or may correspond to or be associated with a particular account, transaction card/device, or program or service that the customer has acknowledged and confirmed. For example, a proof of enrollment may associate the customer's credit card account with a payment protection program and a fraud protection program that the customer has opted to enroll in. In some embodiments, the proof of enrollment may also include data and information that may be used by the financial institution to further confirm the customer's acknowledgement and approval. For example, a proof of enrollment may also include the date and time the customer indicated a desire to enroll in a program or service, as well as the manner such indication was communicated to the financial institution. Other data and information may be provided by the proof of enrollment. In some embodiments, a proof of enrollment may comprise a data file, record or document which correlates particular customer accounts or transaction devices, for example, with particular programs or services that the customer has agreed to be enrolled in.

According to one embodiment of the systems and methods described herein, a computer-implemented method for issuing an obvious and indisputable proof of enrollment corresponding to at least one program or service a user agrees to enroll in or receive is provided. The method comprising the steps of: offering a user at least one program or service and an incentive for enrolling in or receiving the program or service; presenting the user with a video presentation or demonstration, wherein the user is required to view or participate in the video presentation or demonstration in order to enroll in or accept the at least one program or, service; receiving input signals from the user indicating the user's participation in the presentation or demonstration, wherein the input signals received confirm the user's agreement to enroll in or receive the at least one program or service; providing the user with an incentive or value during the presentation or demonstration; and issuing, via a processor, an obvious and indisputable proof of enrollment or acceptance record indicating that the user has elected to enroll in or receive the at least one program, service or value.

In another embodiment of the systems and methods described herein, a system for issuing an obvious and indisputable proof of enrollment corresponding to at least one program or service a user agrees to enroll in or receive is provided. The system comprising: an offer processor for offering a user at least one program or service and an incentive for enrolling in or receiving the program or service; a presentation processor for presenting the user with a presentation or demonstration, wherein the user is required to view or participate in the presentation or demonstration in order to enroll in or accept the at least one program or service; an incentive processor for providing the user with an incentive or value during the presentation or demonstration; and a proof of enrollment processor for issuing an obvious and indisputable proof of enrollment or acceptance record indicating that the user has elected to enroll in or receive the at least one program, service or value.

### BRIEF DESCRIPTION OF THE DRAWINGS

FIG. 1 shows an exemplary system 100 for generating, processing and modifying proofs of enrollment, according to various embodiments of the invention.

FIG. 2 illustrates a process flow for offering a customer a program or service in exchange for an incentive or other reward, according to various embodiments of the invention.

FIG. 2a illustrates a process flow for offering a customer a program or service in exchange for viewing a demo or presentation, according to various embodiments of the invention.

FIG. 2b illustrates a process flow enrolling a customer in a plurality of programs or services, according to various embodiments of the invention.

FIG. 2c illustrates various scenarios for offering a customer an incentive or reward in exchange for the customer enrolling in a program or service, according to various embodiments of the invention.

FIG. 3 illustrates various exemplary modules that may be associated with proof of enrollment processing station 105, according to various embodiments of the invention.

FIG. 4 illustrates a process flow 400 for offering a customer an incentive or reward in exchange for viewing a presentation or demonstration and enrolling in a program or service, according to various embodiments of the invention.

FIG. 5 illustrates a process flow 500 for offering or providing a customer an incentive or reward in exchange for performing a certain task or action, according to various embodiments of the invention.

FIG. 6 illustrates a process flow for receiving a request from a user for an incentive or reward, according to various embodiments of the invention.

### DETAILED DESCRIPTION OF EXEMPLARY EMBODIMENTS

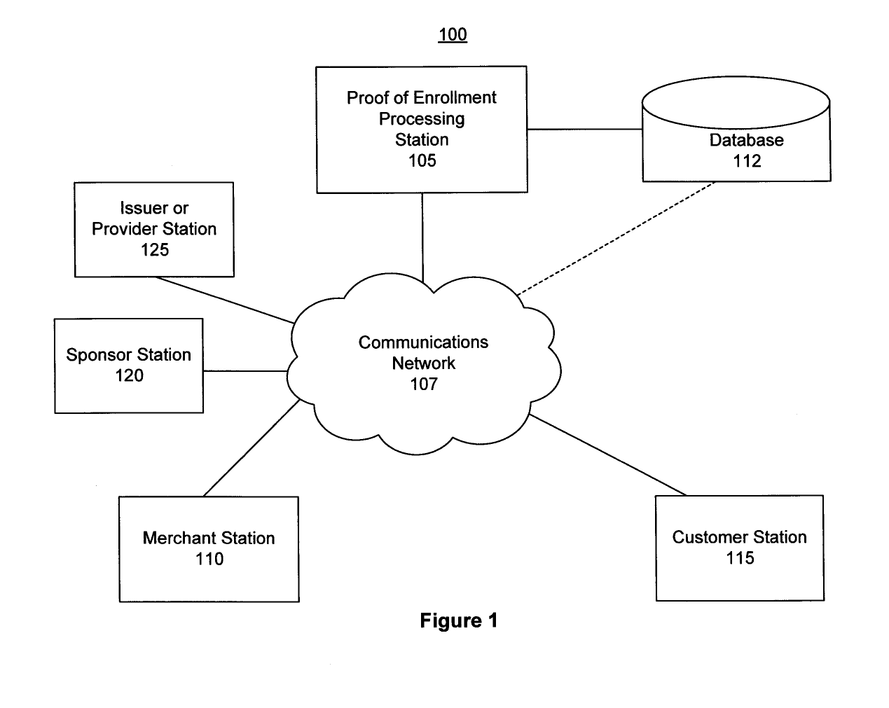

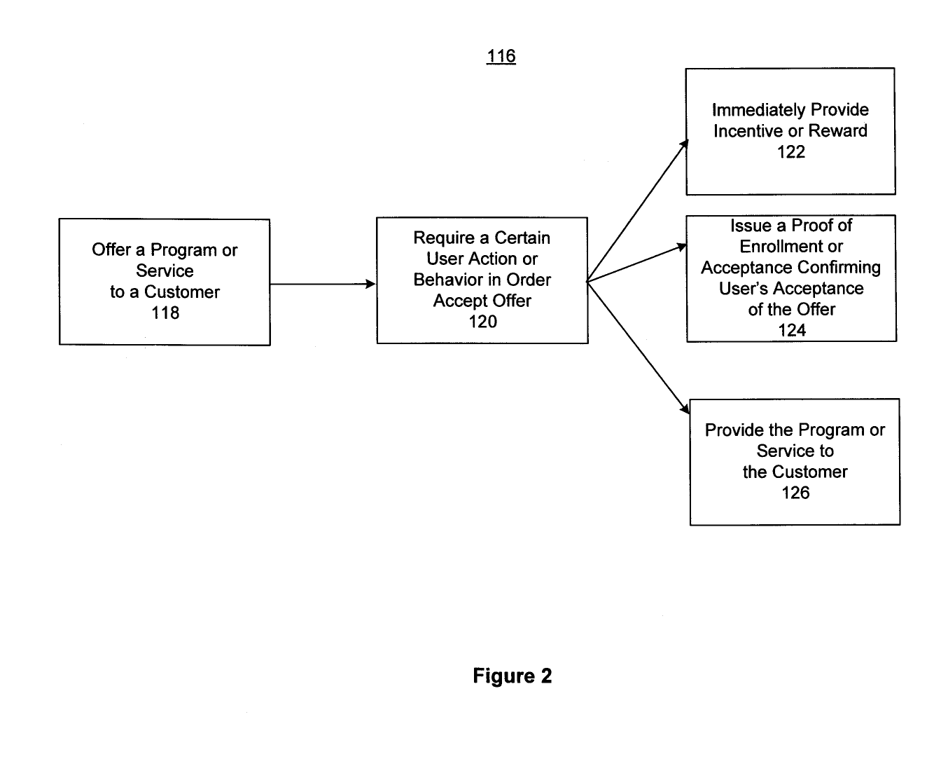

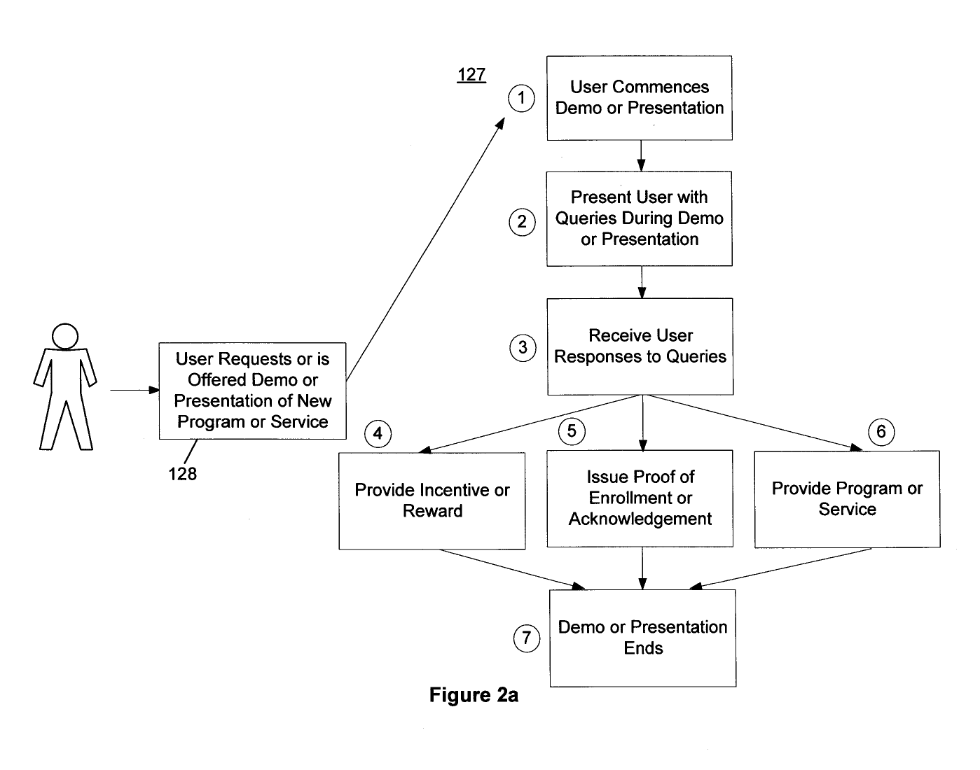

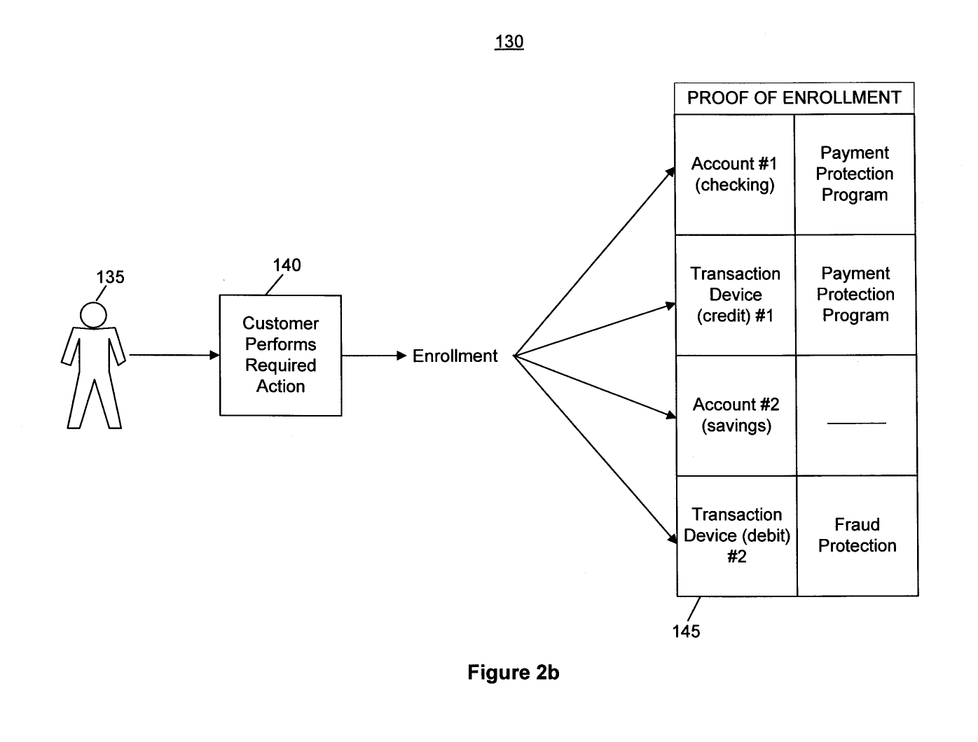

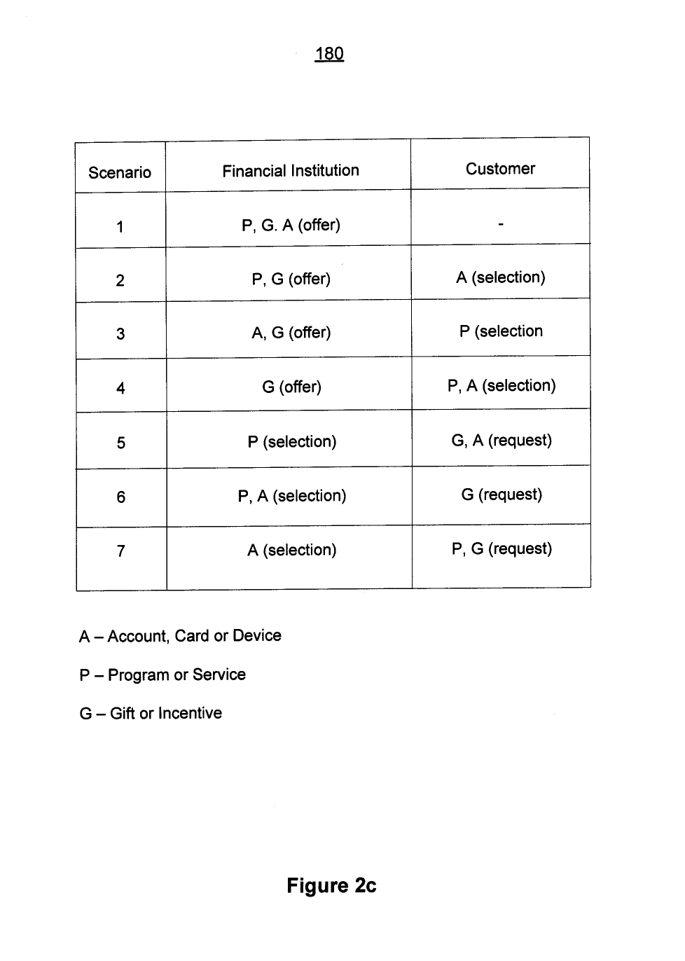

Reference will now be made to the present preferred embodiments of the invention, examples of which are illustrated in the accompanying drawings in which like reference characters refer to corresponding elements. In particular, the invention will be described as implemented on a network or system in FIG. 1, then by demonstrating particular process flows and other corresponding in FIGS. 2-6.

1. Overall System on which the Inventive Concept is Implemented

FIG. 1 illustrates a system 100 for generating and processing proofs of enrollment, according to one embodiment of the invention. System 100 may comprise a proof of enrollment processing station 105, which by itself or in cooperation with other transaction processing systems or networks, provides, generates, stores, issues, processes, modifies or revises proofs of enrollment associated with, among other things, any number of programs or services, customers/users, cards, devices, accounts, financial institutions, merchants or retailers, or sponsors. In some embodiments, proofs of enrollment may be associated with, among other things, programs or services, accounts, customer/users, accounts or transaction cards or devices, merchants or retailers, financial institutions or sponsors, for example. In some embodiments, a proof of enrollment may confirm a user's approval to be enrolled in a particular program or service associated with a particular account or card or device. In some embodiments, proof of enrollment processing station 105 may be administered by a bank, other financial institution, or other third party individual or entity that may provide or issue, or administers accounts or transaction cards or devices, such as cards, for example, (e.g., a card-issuer), a merchant or vendor that sponsors or accepts transaction devices (e.g., a sponsor), or any individual, entity or third party that accepts, coordinates, manages or administers customer use of accounts or transaction cards or devices or other instruments to conduct transactions. In some embodiments, proof of enrollment processing station 105 may maintain or have access to particulars about customers, programs or services, accounts or transaction cards or devices, merchants, and any data or information that may be used to generate and process proofs of enrollment as described herein. In some embodiments, proof of enrollment processing station 105 may comprise a central headquarters or distributed network or repository of the various features and functions of the systems and methods described herein, and may be maintained by or in conjunction with any party or entity that administers the coordination of data and information in connection with the processing of transactions according to the systems and methods described herein.

Proof of enrollment processing station 105 may comprise a single server or engine (as shown). In another embodiment, proof of enrollment processing station 105 may comprise a plurality of servers or engines, dedicated or otherwise, which may further host processors or modules for performing desired system functionality. Proof of enrollment processing station 105, for example, may host one or more applications or modules that function to permit interaction between the users of system 100 (e.g., card holders, customers, merchants, the administrator of proof of enrollment processing station 105, and any other relevant parties) as it relates to exchanging and processing of data and information related to the generation and processing of proofs of enrollment as described herein, for example. For instance, proof of enrollment processing station 105 may include an administration module that serves to permit interaction between the system 100 and the individual(s) or entity(ies) charged with administering system 100 or proof of enrollment processing station 105.

Proof of enrollment processing station 105 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

Data and information maintained by proof of enrollment processing station 105 may be stored and cataloged in database 112 which may comprise or interface with a searchable database. Database 112 may comprise, include or interface to a relational database. Other databases, such as a query format database, a Standard Query Language (SQL) format database, a storage area network (SAN), or another similar data storage device, query format, platform or resource may be used. Database 112 may comprise a single database or a collection of databases, dedicated or otherwise. In one embodiment, database 112 may store or cooperate with other databases to store the various data and information described herein. In some embodiments, database 112 may comprise a file management system, program or application for storing and maintaining data and information used or generated by the various features and functions of the systems and methods described herein. In some embodiments, database 112 may store, maintain and permit access to proofs of enrollment, customer information, program or service information, transaction information, account or card or device information, or any general information used to generate, store or modify proofs of enrollment as described herein. In some embodiments, database 112 is connected directly to proof of enrollment processing station 105, which, in some embodiments, may be accessible through a network, such as communication network 107, for example.

Proof of enrollment processing station 105 may, in some embodiments, be accessed via a communication network 107. Communications network 107 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection.

Communications network 107 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 107 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network 107 may comprise a satellite communications network, such as a direct broadcast communication system (DBS) having the requisite number of dishes, satellites and transmitter/receiver boxes, for example. Communications network 107 may also comprise a telephone communications network, such as the Public Switched Telephone Network (PSTN). In another embodiment, communication network 120 may comprise a Personal Branch Exchange (PBX), which may further connect to the PSTN.

As shown in FIG. 1, merchant station 110 and customer station 115 may communicate with proof of enrollment processing station 105 via communication network 107. Merchant station 110 may comprise, for example, a station utilized by an agent of a merchant to interact or communicate with its customers or proof of enrollment processing station 105. For example, merchant station 110 may comprise a call center facility or station of a merchant or retailer that is associated with the accounts or transaction cards or devices (e.g., a credit, debit or stored value card) to which products or services may be added (e.g., upon viewing a marketing or educational video or demonstration) or which may activated or reloaded as described herein. In some embodiments, merchant station 110 may comprise a point-of-sale system or engine that processes merchant transactions with a customer and which may further cooperate or interact with external systems which carry out card and other transactions (e.g., credit card transactions), including without limitation, for example, proof of enrollment processing station 105. In some embodiments, merchant station 110 may comprise or host web sites or web pages of a merchant or retailer through which customers may interact with the merchant or retailer for any purpose.

Customer station 115 may, in some embodiments, enable a customer of a financial institution, or any other person or entity that may utilize the systems and methods described herein to, among other things, add programs or services to or activate or reload accounts or transaction cards or devices (e.g., a credit, debit or stored value card) that are part of offers presented by financial institutions, for example, as described herein. Customer station 115 may, in general, enable a customer to interact with proof of enrollment processing station 105 in connection with the various features and functionality described herein. For example, customer station 115 may enable a customer to call or access the web site or page of a financial institution, for example.

In some embodiments, customer station 115 may comprise any terminal (e.g., a typical home or personal computer system, telephone, personal digital assistant (PDA) or other like device) whereby a customer may interact with a network, such as communications network 107, for example, that is responsible for transmitting and delivering data and information used by the various systems and methods described herein. Customer station 115 may comprise or include, for instance, a personal or laptop computer, a telephone, or PDA. Customer station 115 may include a microprocessor, a microcontroller or other general or special purpose device operating under programmed control. Customer station 115 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Customer station 115 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Customer station 115 may also include a network-enabled appliance, a browser-equipped or other network-enabled cellular telephone, or another TCP/IP client or other device.

Sponsor station 120 may, in some embodiments, comprise a processing system of a sponsor (e.g., an individual or entity that sponsors an account or transaction card or device that is associated with a program or service as described herein) that interacts or interfaces with proof of enrollment processing station 105 to perform the various features and functionality described herein. For example, sponsor station 120 may comprise the various processors, systems or terminals associated with, among other things, maintaining a listing of individuals or entities entitled to receive certain product or service offers, or any feature or functionality performed by a sponsor that is associated with the systems and methods for providing proofs of enrollment as described herein. In some embodiments, an agent of a sponsor may interact or interface with proof of enrollment processing station 105 via sponsor station 120.

Issuer or provider station 125 may, in some embodiments, comprise a processing system of a financial institution or other account, card or device issuer or provider that interacts or interfaces with proof of enrollment processing station 105 to perform the various features and functionality described herein. In some embodiments, such account, card or device may comprise an account, card or device to which programs or services may be added or which may be activated or reloaded as described herein. For example, issuer or provider station 125 may comprise the various processors or terminals associated with providing or issuing an account, card or device to a customer as described herein. In some embodiments, issuer or provider module 125 station may also comprise third party systems and processors that cooperate with a financial institution or other provider, for example, to provide or issue accounts, cards or devices to individuals, such as, for example, a card vendor's or transaction network's (e.g., Visa™ or MasterCard™) systems or processors.

2. Process Flows and Other Features of the Inventive Concept

FIG. 2 illustrates a process flow 116 showing the general steps involved in offering a particular incentive or reward to a customer in exchange for enrolling in a program or service. At step 118, a customer may be offered a program or service to enroll in. In some embodiments, the program or service may comprise, for example, a payment protection program, a fraud protection program, or other program, service, feature or functionality that may be associated with an account or transaction card or device. In addition, in order to entice customers to enroll in the program or service, the offer may include an incentive or reward that the customer will be provided immediately. The incentives or rewards that may be offered to the customer in exchange for enrolling in or agreeing to receive a program or service may include issuing or reloading a credit, debit, stored value card or other transaction device to the customer, issuing credit or other value to a customer's savings or checking account, increasing the credit limit associated with the customer's credit card, rewarding reward points or other value (e.g., airline miles or points), or other form of incentive or reward.

In some embodiments, the offer may also specify a particular task or action that the customer must perform in order to enroll in the program or service and receive the incentive or reward. For example, the customer may be required to view or participate in a presentation or demonstration (e.g., watching a marketing demonstration or video), make a certain purchase or transaction, activate a transaction card or device, upgrade to a new or different transaction card or device, opt-in to a program or service, approve a certain action or charge, take a survey, use a new program or service, retain a certain program, service, card or device, increase engagement or spending, or any other action or behavior that may confirm or acknowledge the customer's agreement to enroll in or receive the program or service. The offer may be presented to the customer in any suitable method, such as, for example, via mail, electronic mail, instant messaging, or other form of communication. For example, a customer may receive an email or mailer offering the customer an immediate credit line increase if the customer agrees to enroll in a credit protection program associated with the customer's credit card, which enrollment may be confirmed by the user performing a certain designated task or action.

Referring back to FIG. 2, at step 120, the customer may perform the particular action or task. In some embodiments, the action or task may be performed by the customer interacting with the systems and methods described herein. For example, if the customer is required to view a video or demonstration in order to confirm his agreement to enroll in a program or service, the customer's may view the video or presentation through a designated web site or location. Similarly, if the customer is required to activate a stored value card, the customer may perform that task or action by expressly activating the transaction device by interacting with a live customer agent, a designated web site or location, or other appropriate manner.

Once the customer performs the requisite task or action (e.g., view a video presentation or activate a transaction card), the customer may, at step 122, immediately be provided with the offered incentive or action. For example, if the customer is promised a credit line increase, the customer's credit line may immediately be applied once confirmation is received that the customer has performed the required task or action. In addition to being immediately provided with the incentive or reward, a proof of enrollment or acceptance is issued at step 124 which serves to confirm in an obvious and indisputable manner the customer's agreement to enroll in the offered program or service. At step 126, the customer is also immediately enrolled or provided with the program or service.

FIG. 2a depicts an embodiment of the invention wherein a customer is offered an immediate credit line increase (or other reward or incentive) in exchange for viewing a video demo or presentation relating to a new fraud protection program that the bank is offering its credit customers. Upon viewing the video or demonstration, the customer is immediately provided the credit increase and enrolled in the new fraud protection program. In addition, an obvious proof of enrollment is issued to confirm in an indisputable manner the customer's agreement to enroll in the program.

In particular, as shown in step 128, the customer may be offered the incentive or reward in exchange for viewing a demonstration of the fraud program and thereby enrolling in the program. The offer may be presented to the user via a mailer, an email, an instant message, an advertisement, or other form of communication that can convey the offer to the customer. In some embodiments, the offer may be made to the customer upon the customer requesting the incentive or reward from the bank. For example, the customer may approach the bank and request a credit line increase (or other reward), to which the bank may respond by agreeing to increase the credit line, so long as the customer enrolls in the program by viewing the video or demonstration.

Once the customer is presented with the offer, at sub-step 1 the user may initiate or commence the demo or presentation. For example, the email or mailer may include a link or instructions telling the customer to visit a certain web site where the video may be accessed. The web site may be administered by the financial institution making the offer and may enable the customer to interact with the video demonstration. In addition, the video demonstration may provide additional information and details to the customer on the fraud protection program, and make clear to the customer that by viewing the video and answering some questions, for example, the customer is agreeing to enroll in the fraud protection program. The video may also inform or remind the customer that in exchange for viewing the video, the customer is agreeing to enroll in or receive the program. In some embodiments, before viewing the presentation the customer may be required to “sign in” by providing his name, contact information, account or customer information, or any other information that may be used to confirm the customer's viewing of the presentation. During the sign in process, the user may be informed or reminded that by signing in and viewing the video presentation, the customer is agreeing to be enrolled in the program. Thus, as soon as the customer signs in (or sometime thereafter), the customer is enrolled in the program.

At sub-step 2, during the video demonstration the customer may be presented with queries relating to the program(s) being offered. For example, if more than one program is being offered (e.g., a fraud protection program and a payment protection program), the customer may be provided details and benefits of each program, as well as queried as to which programs the user would like to enroll in. In some embodiments, rather than enrolling the customer at sign in, additional confirmation may be received from the customer before enrollment occurs. For example, following a description of fraud protection program, the video demonstration may stop and ask the user the following question:

VOICE IN VIDEO: “Now that you have the details on our new fraud protection program, please indicate your agreement to enroll in the program by pressing 1 on your keyboard (or saying “Yes”), or 2 (or “No”) to decline.”

In response to the query, at sub-step 3, the user may press the appropriate key, the customer's selection may be acknowledged and recorded, and the video demonstration may then proceed to provide additional information to the customer or conclude. In some embodiments, the user may orally speak the response to the query, which response may be received and/or recorded in audible form and used to confirm the user's agreement to enroll. For example, the user's audible response may be picked up by a receiver at the user's location (e.g., microphone connected to user's computer) and transmitted to proof of enrollment processing station 105 for processing and generation of appropriate proofs of enrollment, for example. Other user responses or selections during the video demonstration may be received or recorded in a similar manner. Once the customer participates in the video demonstration and provides responses to the queries presented confirming an agreement to enroll, then at sub-step 4 the customer may be provided with the incentive or request (this may occur immediately upon the user confirming his agreement to enroll in the program, during the video presentation, or sometime thereafter). At sub-step 5, a proof of enrollment may be issued which confirms the customer's agreement to enroll in the program in an indisputable manner. At sub-step 6 the customer may be provided or enrolled in the appropriate program or service. It should be noted, however, that sub-steps 4-6 do not have to proceed in the order shown. Ideally, however, sub-steps 4-6 should occur immediately upon receiving confirmation that the user has agreed to enroll in the program, or at least before termination of the video demonstration at sub-step 7. In this way, the customer is sure to receive the incentive or reward and the benefits of enrollment in a quick and reliable manner. In addition, the bank is able to generate immediate confirmation via the indisputable proof of enrollment that the customer has agreed to enroll in the program.

In some embodiments, fraud prevention steps and techniques may be utilized to ensure that a participant performing a required task or action is the intended participant and not an unauthorized third party. For example, if the participant is interacting with an online portal or web site, the participant may be required to provide certain information that allow the individual to be authenticated. For example, the user may be required to provide a username and password, or answer a question that only the individual would know the answer to. In some embodiments, the participant may be recorded during the performance of the task or action, such as, for example, having the individual's image be taken during performance of the required action or task. Fraud may also be prevented by accessing data associated with the participant's computer, such as, for example, the computer's IP address or other like identifier. Of course, in situations where the user's image is taken or information is acquired from the individual's computer, for example, prior approval from the individual would need to be secured or other measures taken to ensure privacy is not violated. In addition, a user may be required to type in obscured words that appear on the screen to prevent an Internet or web robot (or bot), for example, from improperly accessing the site or content. Other fraud and security measures may be taken.

Referring now to FIG. 2b, the invention may also permit the customer to determine which transactions cards or devices a particular program or service the customer agrees to enroll in should be applied to. This is particularly beneficial if the customer has more than one account, card or device with the financial institution. For example, if the customer is offered the opportunity to enroll in a fraud or credit protection program, the customer is able to determine which of his accounts, transactions cards or device the program(s) should be applied to. FIG. 2b, for example, illustrates one embodiment of a process flow 130 showing the customer determining which account(s) or transaction device(s) are to be enrolled in a particular program or service. As shown, upon the customer performing the required task or action (e.g, viewing the required video demonstration) at step 140, the customer may be presented with the opportunity to designate which account(s), card(s) or device(s) the customer wants enrolled in the program(s). For purposes of this example, customer 135 is assumed to have four accounts/devices: (1) a checking account (account #1), (2) a credit card (transaction device #1), (3) a savings account (account #2), and a debit card (transaction device #2).

As shown in FIG. 2b, the particular proof of enrollment in this example indicates that by viewing the video or demonstration, the customer's 135 may make the following designations:

(1) apply the payment protection program to my checking account,

(2) apply the payment protection program to my credit card,

(3) do not apply any program to my savings account, and

(4) apply the fraud protection program to my debit card.

As a result of the customer's designations and selections, the proof of enrollment generated by the customer's actions and selections indicates/correlates the selected program(s) or service(s) with the appropriate account(s), card(s) or device(s). In particular, the checking account has been associated with the payment protection program; the credit card has been associated with the payment protection program; the savings account has not been associated with any program or service; and the debit card has been associated with fraud protection.

In addition, the invention is not limited to scenarios where the financial institution determines the nature of the programs or services or incentives or rewards offered to the customer. In some embodiments, the customer may determine the program or service or incentive or reward the user is interested in. In fact, the customer need not wait for the financial institution to make the offer, but may instead approach the financial institution and indicate a willingness to enroll in a particular program or service in exchange for a particular incentive or reward. FIG. 2c illustrates a table 180 which illustrates various parameter schemes that may be used to provide an incentive or reward in exchange for enrolling in a programs or services. In particular, table 180 presents eight (8) scenarios where the system and methods described herein process three variables that are required in order to perform the generation and issuance of proofs of enrollment. The three variables are: (1) the programs or services that a customer is to be enrolled in, (2) the identity of accounts, cards or devices that are to be associated with the programs or services, and (3) the type of incentive or reward the customer is to receive in exchange for enrolling in or agreeing to receive the program or service. Some combination of these three variables may be presented or determined by the financial institution or the customer. Each scenario is described below. Other scenarios are of course possible.

Scenario 1—In this scenario the financial institution presents the customer with an offer to enroll in a program or service (“P”) that is to be associated with a certain account, card or device (“A”). In exchange for enrolling in the program or service, the customer is offered an incentive, reward (e.g., gift) (“G”). In this scenario the financial institution determines all three variables. The customer can only decide whether to accept or reject the offer.

Scenario 2—In this example the customer receives the same offer as in scenario 1, except the customer gets to determine the account(s), card(s) or device(s) that are to be associated with the offered programs or services.

Scenario 3—In this example the customer receives the same offer as in scenario 1, except the customer gets to determine the program(s) or service(s) that the customer wishes to enroll in.

Scenario 4—In this example the customer receives the same offer as in scenario 1, except the customer gets to determine the program(s) or service(s) that the customer wishes to enroll in, as well as the account(s), card(s) or device(s) that are to be associated with the selected programs or services.

Scenario 5—In this scenario, rather than waiting for an offer to come in from the financial institution, the customer may approach the financial institution and request—which may be unsolicited—a certain incentive, reward or gift and a willingness to enroll in a program or service associated with an account, card or device to be determined by the customer. In this situation the financial institution may agree to the request, but may impose any number of program(s) or service(s) that the customer must enroll in to receive the requested incentive or reward. In this example, the financial institution may also impose other requirements and obligations on the customer. Alternatively, in scenario 5, the financial institution may present the customer with an offer to enroll in a certain program(s) or service(s), and the customer gets to select the incentive or reward it wishes to receive as well as the account, card or device that will be associated with the program(s) or service(s) offered.

Scenario 6—In this situation, as in scenario 5, the customer may approach the financial institution and express a desire—which may be unsolicited—to receive a certain incentive or reward. Upon receiving this request from the customer, the financial institution may agree to the request, but may impose any number of program(s) or service(s) that the customer must enroll in to receive the requested incentive or reward, as well as specify the account(s), card(s) or device(s) that must be associated with the selected program(s) or service(s). In this example, the financial institution may also impose other requirements and obligations on the customer. Alternatively, in scenario 6, the financial institution may present the customer with an offer to enroll in certain program(s) or service(s) and the corresponding account(s) card(s) or device(s), and the customer gets to select the incentive or reward it wishes to receive.

Scenario 7—In this scenario, as in scenario 5, the customer may approach the financial institution and request—which may be unsolicited—a certain incentive or reward in exchange for a willingness to enroll in a certain program or service. The financial institution may agree to the request, but may impose any number of account(s), card(s) or device(s) that the customer must apply the program(s) or service(s) to in order to receive the requested incentive or reward. In this example, the financial institution may also impose other requirements and obligations on the customer. Alternatively, in scenario 7, the financial institution may present the customer with an offer to enroll in a program(s) or service(s) with a certain account, card or device, and the customer gets to select the incentive or reward it wishes to receive as well as the program(s) or service(s) that will be associated with the account(s), card(s) or device(s) determined by the financial institution.

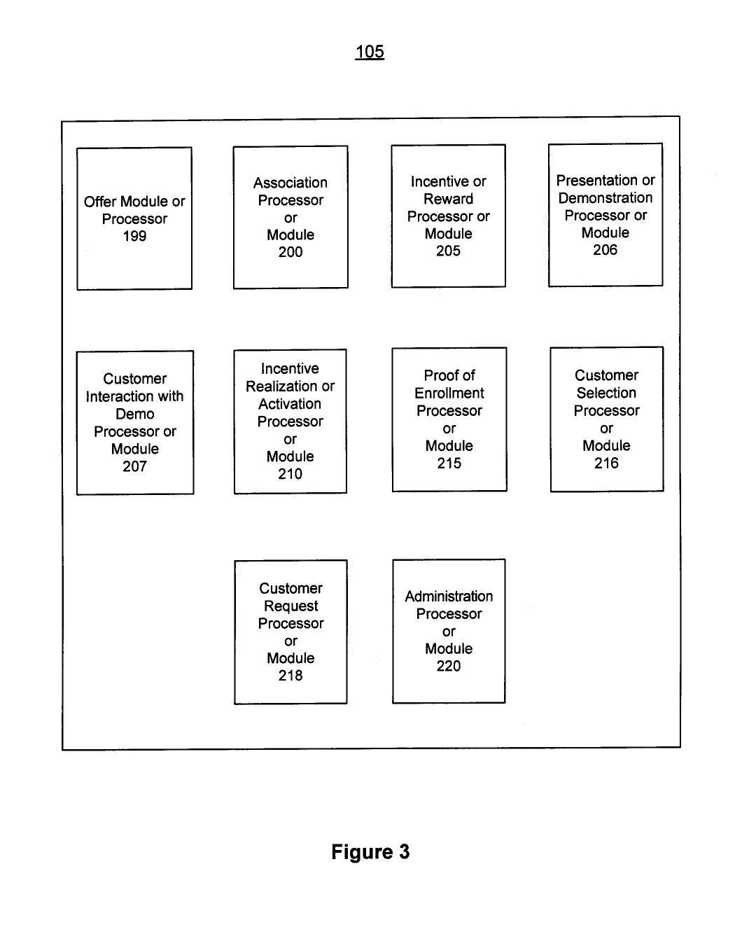

FIG. 3 illustrates exemplary processors or modules that may be associated with proof of enrollment processing station 105 for carrying out (or administering) the various functions and features of the embodiments described herein, including but not limited to the features and functionality described in FIGS. 2-2c. In some embodiments, the various modules are associated with or interact with the network or systems which administer an account or card or transaction device. In some embodiments, each of the modules may be accessed by a customer or card holder, for example, via an online portal (e.g., a web site) that presents to the user the various features or functionality or interfaces associated with the activation of accounts, cards or devices, as well as the selection of offer parameters as described herein. Such online portal may also permit the customer to provide the necessary data or information required to activate transaction devices or accounts and generate or modify proofs of enrollment. In some embodiments, each module may present the user with various graphical user interfaces (GUIs) which present or solicit information from the user that is needed to implement the features and functionality described herein. Other features and functionality are of course possible. While the modules may not be used in all embodiments to perform some or all of the functions of the present invention, they are nonetheless presented as possible embodiments:

Offer module or processor 199 may, in some embodiments, operate to compose the particulars of offers to customers, which offers may comprise a particular incentive or reward to be offered to a customer, as well as a program or service that by performing a certain task or action the customer would be automatically enrolled in. In some embodiments, the program or service may comprise, for example, a payment protection program, a fraud protection program, or other program, service, feature or functionality that may be associated with an account or transaction card or device. In addition, in order to entice customers to enroll in the program or service, the offer may include an incentive or reward that the customer will be provided immediately. The incentives or rewards that may be offered to the customer in exchange for enrolling in or agreeing to receive a program or service may include issuing or reloading a credit, debit, stored value card or other transaction device to the customer, issuing credit or other value to a customer's savings or checking account, increasing the credit limit associated with the customer's credit card, rewarding reward points or other value (e.g., airline miles or points), or other form of incentive or reward. The particular task or action that the customer must perform in order to enroll in the program or service and receive the incentive or reward may comprise: requiring the customer to view or participate in a presentation or demonstration (e.g., watching a marketing demonstration or video), make a certain purchase or transaction, activate a transaction card or device, upgrade to a new or different transaction card or device, opt-in to a program or service, approve a certain action or charge, take a survey, use a new program or service, retain a certain program, service, card or device, increase engagement or spending, or any other action or behavior that may confirm or acknowledge the customer's agreement to enroll in or receive the program or service.

The offer may be presented to the customer in any suitable method, such as, for example, via mail, electronic mail, instant messaging, or other form of communication. For example, a customer may receive an email or mailer offering the customer an immediate credit line increase if the customer agrees to enroll in a credit protection program associated with the customer's credit card, which enrollment may be confirmed by the user performing a certain designated task or action.

Association processor or module 200 may, in some embodiments, operate to associate programs or services with incentives or rewards to be offered to customers. For example, association processor or module 200 may associate programs or services (e.g., fraud protection) with a particular account or transaction card or device (e.g., a credit line increase, loading or adding value to an account, or a gift card for a particular value) that is to be offered to customers as part of a promotional. In some embodiments, the association of programs or services to incentives or rewards may be made by the financial institution, while in some embodiments the association may be made by the customer.

Incentive or reward processor or module 205 may, in some embodiments, operate to issue or provide (or cooperate with or request other systems to issue or provide) the incentive or reward that is being offered to a customer in exchange for enrolling in a program or service. For example, incentive or reward processor or module 205 may, upon receiving confirmation of a customer's agreement to enroll in a program or service, effectuate (or cooperate with or request other systems to effectuate) the issuance of credit or value to an account or device, the issuance of points, rewards or other value to a customer, or other form of incentive or reward that may be given to a customer in exchange for enrolling in the program or service. For example, incentive or reward processor or module 205 may itself (or cooperate with or request other systems to) increase a customer's credit limit, reduce a customer's interest rate or monthly payment, or provide other like financial incentives. In some embodiments, incentive or reward processor or module 205 may issue (or cooperate with or request other systems to issue) an account, card or device loaded with value to be activated or otherwise initiated by the customer. The account, card or device may be associated with a particular value and may be redeemable or used for transactions at select merchants or retailers. In some embodiments, incentive or reward processor or module 205 may be part of or interact or cooperate with the systems and methods of a merchant or retailer that is associated with the incentive or reward being provided.

Presentation or demonstration module or processor 206 may, in some embodiments, present the particular video demonstration or presentation that a customer is required to view or participate in to confirm the customer's agreement to enroll in a program or service. In some embodiments, presentation or demonstration module or processor 206 may present the video demonstration or presentation to the customer through a web site or other network location, for example, that the customer can access. For example, an email or mailer presenting an offer to a customer may include a link or instructions telling the customer to visit a certain web site where the video may be accessed. The web site may belong to or be associated with the financial institution making the offer and may enable the customer to interact with the video demonstration. In addition, the video demonstration may provide additional information and details to the customer on the programs or services being offered, and make clear to the customer that by viewing the video and answering some questions, for example, the customer is agreeing to enroll in the offered program or service. In some embodiments, before viewing the presentation the customer may be required to “sign in” by providing his name, contact information, account or customer information, or any other information that may be used to confirm the customer's viewing of the presentation. During the sign in process, the user may be informed or reminded that by signing in and viewing the video presentation, the customer is agreeing to be enrolled in the program. Thus, as soon as the customer signs in (or sometime thereafter), the customer is enrolled in the program.

In some embodiments, the video demonstration may present the customer with queries relating to the program(s) being offered. For example, if more than one program is being offered (e.g., a fraud protection program and a payment protection program), the customer may be provided details and benefits of each program, as well as be asked which programs the user would like to enroll in. In some embodiments, rather than enrolling the customer at sign in, additional confirmation may be received from the customer before enrollment occurs. For example, the customer may be specifically asked whether he or she would like to enroll in the particular program or service being offered. Other questions may of course be asked.

Customer interaction module or processor 207 may, in some embodiments, receive and process user responses to queries presented in a video demonstration or presentation. For example, upon being asked whether the user agrees to be enrolled in the program being offered, the user's response may be acknowledged and recorded, and the video demonstration may then proceed to provide additional information to the customer or conclude. Once the customer participates in the video demonstration and provides responses to the queries presented confirming an agreement to enroll, then the customer may be provided with the incentive or request (this may occur immediately upon the user confirming his agreement to enroll in the program, during the video presentation, or sometime thereafter), an obvious and indisputable proof of enrollment may be issued which confirms the customer's agreement to enroll in the program in an indisputable manner, and the customer may be provided or enrolled in the program or service being offered.

In some embodiments, customer interaction module or processor 207 may interact with external systems to confirm that the customer has performed the required task or action necessary to enroll in the program or service being offered and receive the incentive or reward. For example, if the customer is required to make a certain purchase or transaction, upgrade to a new or different account or card, opt-in to a new program, approve a certain action, take a survey, use a new service, or other like task or action, customer interaction module or processor 207 may interact with the appropriate systems that track the user's performance of such task or action and receive confirmation from such system that the task or action has been performed.

Incentive realization or activation processor or module 210 may, in some embodiments, operate to activate incentives or rewards (e.g., accounts, cards, or devices) issued by incentive or reward processor or module 205. For example, when the incentive or reward requires activation or other initiation by the customer in order for the incentive or reward to be effected, such activation or initiation may be accomplished by incentive realization or activation processor or module 210. In some embodiments, incentive realization or activation processor or module 210 may be accessed by a customer via a communications network (e.g., the Internet) so that the customer may take the necessary steps and provide the necessary information to activate the incentive or reward. In some embodiments, activation of an account, card or device may occur automatically (e.g., upon the customer taking possession of the account, card or device), and immediately result in the generation and issuance of an indisputable proof of enrollment as described herein. In some embodiments, upon receiving an activation request from a customer (either directly or through a live agent or an IVR), incentive realization or activation processor or module 210 may interact or cooperate with proof of enrollment processor or module 215 to initiate the process of generating a indisputable proof of enrollment that confirms the customer's agreement to enroll in the offered program or service. In some embodiments, incentive realization or activation processor or module 200 may be part of or interact or cooperate with an activation center that serves the financial institution associated with a particular offer to enroll.

In some embodiments, incentive realization or activation processor or module 210 may be accessed by a live agent representative of a financial institution or by an IVR in order to activate the account, card or device. In some embodiments, the various systems and methods described herein may operate on the basis of an agent or IVR script or scripts that presents an incoming customer, for example, with select questions and queries that enable proof of enrollment processing station 105, for example, to activate the incentive or reward and accordingly enroll a customer in all appropriate programs or services associated with the incentive or reward.

Proof of enrollment processor or module 215 may, in some embodiments, process, generate and issue proofs of enrollment corresponding to a customer's approval to enroll in any number of programs or services that have been offered. For example, upon receiving confirmation that the customer has performed the required task or action (e.g., view a required video demonstration relating to the program or service being offered), proof of enrollment. Likewise, upon receiving an activation signal from incentive realization or activation processor or module 210 indicating that a customer has activated an account, card or device, proof of enrollment processor or module 215 may generate a proof of enrollment (e.g., a file, document or record) that correlates all programs or services that a customer has enrolled in. If the program enrolled in is to be a associated with designation accounts, cards or devices (e.g., a fraud protection program being associated with certain accounts, cards or devices of the customer), then the proof of enrollment may indicate which programs have been associated with which accounts, cards or devices. In some embodiments, additional data and information relating to the customer's enrollment may also be included in the proof of enrollment, such as, for example, the date, time and manner (e.g., by performing the requisite task or action, or whether via live agent, IVR or online interaction) the enrollment was effected.

Customer selection processor or module 216 may, in some embodiments, receive and process customer selections relating to offers or requests as described herein. In some embodiments, for example, customer selection processor or module 216 may be used by a customer to select programs or services that the customer desires to enroll in, as well as accounts, cards or devices that are to be associated with the selected programs or services. In some embodiments, any of the scenarios of FIG. 2c requiring customer selection or input may be processed by customer selection processor or module 216. For example, during interaction with a video demonstration or presentation relating to

Customer request processor or module 218 may, in some embodiments, permit a customer to make unsolicited requests for an incentive or reward to be received in exchange for agreeing to enroll in a particular program or service. For example, a customer may request a credit line increase, monthly payment reduction, issuance of an account, card or device loaded with or other incentive or reward in exchange for agreeing to enroll in a program or service associated. In some embodiments, the request is received via a live agent or IVR, while in some embodiments it may be received via an online communication (e.g. via a web site or page). The request may specify particulars of the requested incentive or reward, such as, for example, the value stored or associated with an account, card or device, transaction particulars associated with the account, card or device (e.g., where it can be used and for what types of purchases or transactions), or any other particular that may be used to define the terms or conditions or use of the requested incentive or reward. Upon receiving the request, customer request processor or module 218 may assess the request and determine terms or conditions that may need to be met for the customer to receive the requested incentive or reward. In some embodiments, such terms or conditions may comprise at least one program or service that the customer must enroll in order to receive the requested incentive or reward. If the customer agrees to the required terms and conditions, the requested incentive or reward may be made available to the customer as appropriate. In some embodiments, upon receiving or activating the incentive or reward, the customer may be automatically enrolled in the at least one program or service as described herein. Further, a proof of enrollment is generated and issued as described herein.

Administration module 220 may, in some embodiments, enable an administrator of proof of enrollment processing station 105, for example, to interact with the various modules, features and functionality described herein. For example, an agent of proof of enrollment processing station 105 may interact with administration module 220 to input, revise and remove data and information used by the various systems and methods described herein, such as, for example, customer information, merchant information, transaction information, or any other data or information that may be used to perform the various features and functionality described herein. In some embodiments, administration module 220 may enable an administrator of proof of enrollment processing station 105 to establish parameters or rules associated with the various features and functionality described herein. For example, an administrator may establish limits, caps, delays, rules or fees associated with a customer's use of the various proof of enrollment described herein. A customer may also be required to pay a fee to be able to be able to process transactions and select accounts as described herein. Such a fee may be, for example, annually or monthly imposed or may be charged on a one-time or per-transaction basis. In some embodiments, the fee may comprise a monetary amount or any other form of measurable value.

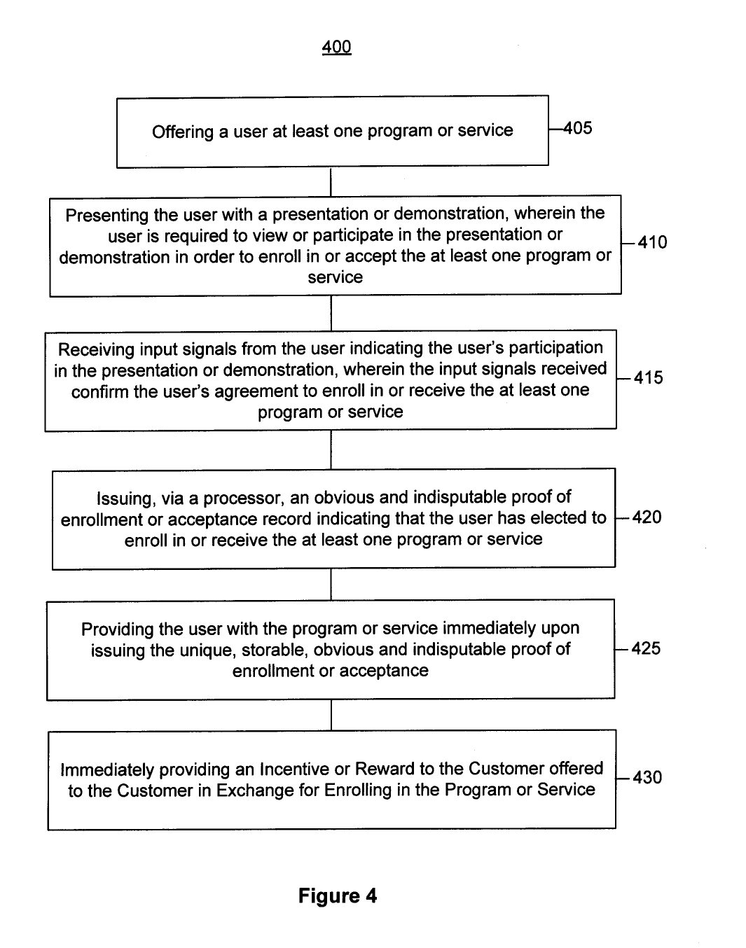

FIG. 4 depicts one embodiment of a process for offering an incentive or reward to a customer in exchange for enrolling in a program or service. At step 405, the customer is presented with an offer to enroll in at least one program or service, which enrollment may be effected by viewing a required video demonstration or presentation. In some embodiments, the offer may include an incentive or reward to induce enrollment in the program or service. At step 410, the customer is presented with the presentation or demonstration. The customer may be instructed to access the video demonstration or presentation by visiting a certain web site or other location (e.g., a link to the video or demonstration). The instructions may be provided as part of the offer, which may be made in an email, mailer or other form of communication. The offer may also state that the user is required to view or participate in the presentation in order to enroll in the program or service and receive the incentive or reward.

At step 415, input signals may be received from the user indicating the user's participation in the video demonstration or presentation. For example, the input signals may comprise user data and information provided during a sign-in stage of the video presentation. In some embodiments, the input signals may comprise user responses to queries presented during the video presentation. For example, the user may be expressly asked whether he or she would like to enroll in the program. The user's responses to the queries presented may confirm the customer's agreement to enroll in the program.

At step 420, upon receiving confirmation that the user has agreed to enroll in the program (e.g., either by participating in the video presentation or by receiving responses to queries), an obvious and indisputable proof of enrollment may be issued which confirms the user's agreement to enroll in the program. At step 425, the user may then be provided with the program or service he has agreed to enroll in. At step 430, the user may be immediately provided with the incentive or reward that is offered in exchange for participating in the video presentation and enrolling in the program or service.

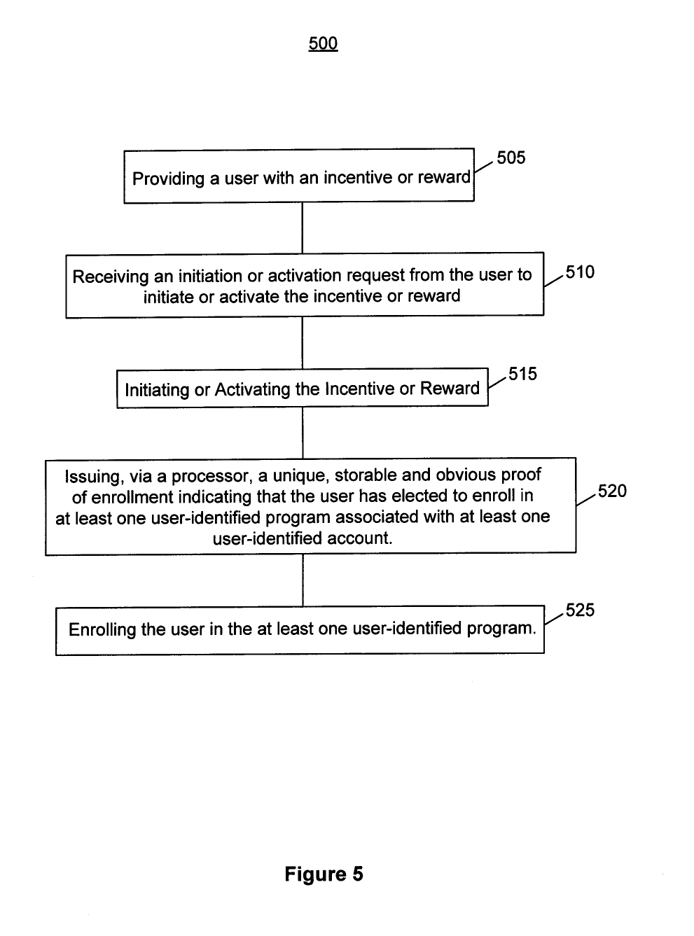

FIG. 5 depicts one embodiment of a process for: (1) offering an incentive or reward in exchange for enrolling in a program or service, and (2) generating an indisputable proof of enrollment which confirms a user's agreement to enroll in the program. At step 505, a user may be offered an incentive or reward in exchange for enrolling in a program or service. In some embodiments, the incentive or reward may be inactive (e.g., an inactive stored value card). In some embodiments, the offer may include a certain task or action that the user must perform in order to enroll in the program or service and receive the incentive or reward. At step 510, an activation request may be received from the user to activate the incentive or reward. In some embodiments, the activation request is initiated upon the user performing the required task or action. At step 515, the incentive or reward may be activated. At step 520, a unique, storable, obvious and indisputable proof of enrollment data file, record or document may be issued indicating that the user has elected to enroll in the program or service. At step 525, the customer may be enrolled in the program. In some embodiments, the at least one program may be identified by the financial institution or the user.

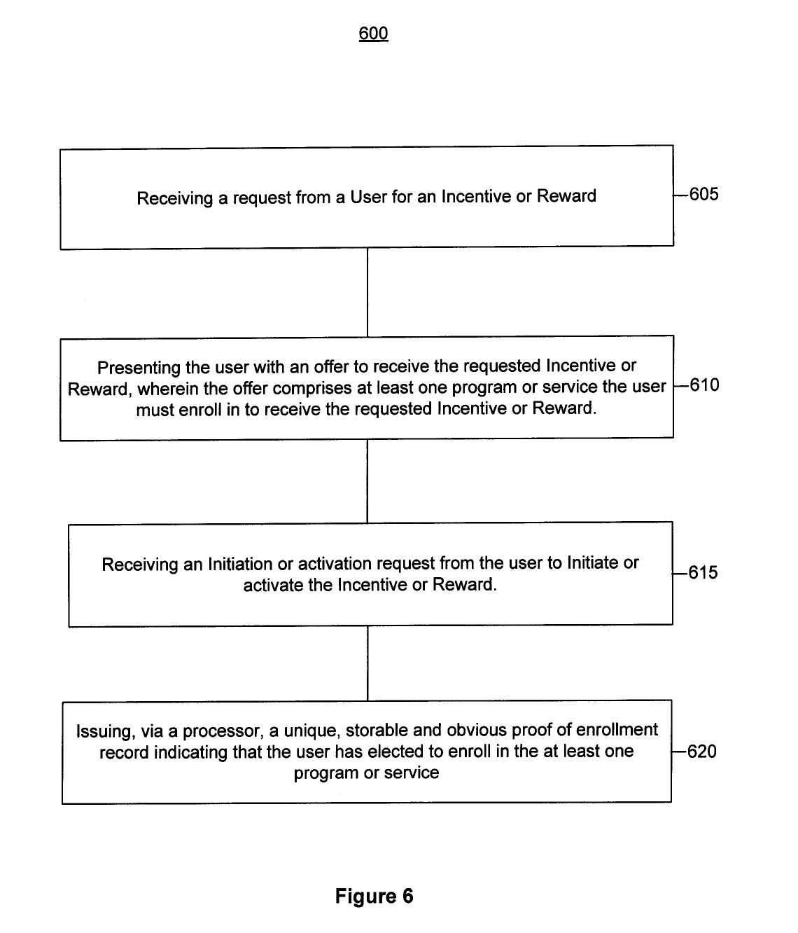

FIG. 6 illustrates a process for receiving a request from a customer for an incentive or reward. At step 552, an unsolicited request from a user is received for an incentive or reward (e.g., a credit line increase, a reduced interest or monthly payment, an account, card or device loaded with value, or other like incentive or reward.) The request may be received via a live agent, IVR or online communication (e.g., via a web site or page). At step 554, the user may be presented with an offer to receive the requested incentive or reward, wherein the offer comprises at least one program or service the user must enroll in to receive the requested incentive or reward, as well as an task or action the user must perform in order to receive the incentive or reward and enroll in the program. The offer may be presented during the communication wherein the request is received, while in some embodiments the offer may be presented subsequent thereto. At step 556, an initiation or activation request is received indicating that the user has performed the required task or action. At step 558, a unique, storable and obvious proof of enrollment record indicating that the user has elected to enroll in the at least one program or service is generated and issued.

Hereinafter, aspects of implementation of the invention will be described. As described above, FIG. 1 shows embodiments of a system of the invention. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example. As described herein, a module performing functionality may comprise a processor and vice-versa.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

The embodiments of the present inventions are not to be limited in scope by the specific embodiments described herein. For example, although many of the embodiments disclosed herein have been described with reference to contribution of money or funds to a transactions device, the principles herein are equally applicable to the contribution of any type of benefit, reward or other value that may identified and contributed to a transactions device. In addition, although many of the embodiments disclosed herein have been described with reference to a savings and transactions processing station that is associated with an administrator of financial instrument or device programs, such as a bank, for example, it should be appreciated that various aspects of the invention may be accomplished when various system components are located elsewhere or administered by other individuals or entities. For instance, the proof of enrollment processing station 105 described herein may be maintained and administered by a third party service provider. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

1. A computer-implemented method for issuing an obvious and indisputable proof of enrollment corresponding to at least one program or service a user agrees to enroll in or receive, comprising the steps of:
offering a user at least one program or service and an incentive in exchange for enrolling in or receiving the at least one program or service;
presenting the user with a video presentation or demonstration that is required in order to enroll in or receive the at least one program or service;
receiving input signals from the user indicating the user's viewing or participation in the presentation or demonstration such that the input signals received confirm the user's agreement to enroll in or receive the at least one program or service;
upon receiving the input signals, generating an obvious and indisputable proof of enrollment or receipt record and correlating the at least one program or service with one or more accounts with which the at least one program or service is associated with;
providing the user with an incentive or value following the presentation or demonstration; and
issuing, via a processor, the obvious and indisputable proof of enrollment or receipt record, indicating that the user has elected to enroll in or receive the at least one program, service or value.

2. The method of claim 1 wherein the at least one program or service comprises a program or service associated with a transaction card or device.

3. The method of claim 1 wherein the incentive or value comprises one or more of: (1) loading value onto and issuing a stored value card to the user, (2) loading value to an account of the user, (3) increasing a credit limit associated with a credit card or account, (4) rewarding points or other reward value to the user; (5) enrollment in the at least one program or service related to a user transaction device or account; (6) lowering an interest rate or other fee associated with account or device; and (7) making payment on an account or device balance on behalf of the user.

4. The method of claim 1 wherein the presentation or demonstration relates to the at least one program or service being offered.

5. The method of claim 1 wherein the input signals are received in response to at least one query presented to the user during the presentation or demonstration.

6. The method of claim 1 wherein the queries relate to the at least one program, service or value.

7. The method of claim 1 wherein the unique, storable, obvious and indisputable proof of enrollment or receipt record is issued upon receiving the input signal from the user.

8. The method of claim 1 further comprising the step of confirming,
during the presentation or demonstration, that the user has opted to enroll in or receive the at least one program, service or value.

9. The method of claim 1 wherein the input signals are received over a data communications network.

10. The method of claim 9 wherein the communications network comprises the Internet.

11. A system for issuing an obvious and indisputable proof of enrollment corresponding to at least one program or service a user agrees to enroll in or receive, comprising:
an offer processor for offering a user at least one program or service and an incentive in exchange for enrolling in or receiving the at least program or service;
a presentation processor for presenting the user with a presentation or demonstration that is required in order to enroll in or receive the at least one program or service;
an incentive processor for providing the user with an incentive or value following the presentation or demonstration; and
a proof of enrollment processor for:
correlating the at least one program or service with one or more accounts with which the at least one program or service is associated with,
generating an obvious and indisputable proof of enrollment or receipt record, upon receiving input signals confirming the user's viewing or participation in the video presentation or demonstration, and
issuing the obvious and indisputable proof of enrollment or receipt record, indicating that the user has elected to enroll in or receive the at least one program, service or value.

12. The system of claim 11 wherein the program or service comprises a program or service associated with a transaction card or device.

13. The system of claim 11 wherein the incentive or value comprises one or more of: (1) loading value onto and issuing a stored value card to the user, (2) loading value to an account of the user, (3) increasing a credit limit associated with a credit card or account, (4) rewarding points or other reward value to the user; (5) enrollment the in a program or service related to a user transaction device or account; (6) lowering an interest rate or other fee associated with account or device; and (7) making payment on an account or device balance on behalf of the user.

14. The system of claim 11 wherein the presentation or demonstration relates to the at least one program or service being offered.

15. The system of claim 11 wherein the input signals are received in response to at least one query presented to the user during the presentation or demonstration.

16. The system of claim 11 wherein the queries relate to the at least one program, service or value.

17. The system of claim 11 wherein the unique, storable, obvious and indisputable proof of enrollment or receipt record is issued upon receiving the input signal from the user.

18. The system of claim 11 further comprising the step of confirming, during the presentation or demonstration, that the user has opted to enroll in or receive the at least one program, service or value.

19. The system of claim 11 wherein the input signals are received over a data communications network.

20. The system of claim 19 wherein the communications network comprises the Internet.

21. The method of claim 1 wherein the user is presented with a security question that must be properly answered in order to continue with the video demonstration or presentation.

22. A computer-implemented method for issuing an obvious and indisputable proof of enrollment corresponding to at least one program or service a user agrees to enroll in or receive, comprising the steps of:
offering a user at least one program or service and an incentive in exchange for enrolling in or receiving the at least one program or service, wherein the at least one program or service comprises a program or service associated with a transaction card or device, and wherein the incentive or value comprises one or more of: loading value onto and issuing a stored value card to the user, loading value to an account of the user, increasing a credit limit associated with a credit card or account, rewarding points or other reward value to the user, enrollment the in a program or service related to a user transaction device or account, lowering an interest rate or other fee associated with account or device, and making payment on an account or device balance on behalf of the user;
presenting the user with a video presentation or demonstration that is required in order to enroll in or receive the at least one program or, service, and wherein the presentation or demonstration relates to the at least one program or service being offered;
receiving input signals from the user indicating the user's participation in the presentation or demonstration such that the input signals received confirm the user's agreement to enroll in or receive the at least one program or service, and wherein the input signals are received in response to at least one query presented to the user during the presentation or demonstration, and wherein the input signals are received over a data communications network;
upon receiving the input signals, generating an obvious and indisputable proof of enrollment or receipt record and correlating the at least one program or service with one or more accounts with which the at least one program or service is associated with;
providing the user with the incentive or value following the presentation or demonstration;
issuing, via a processor, the obvious and indisputable proof of enrollment or receipt record, indicating that the user has elected to enroll in or receive the at least one program, service or value, wherein the unique, storable, obvious and indisputable proof of enrollment or receipt record is issued upon receiving the input signal from the user; and
confirming during the presentation or demonstration that the user has opted to enroll in or receive the at least one program, service or value.

23. The method of claim 1 wherein the obvious and indisputable proof of enrollment or receipt record comprises at least one of: a date of enrollment, a time of enrollment, and a user action indicating enrollment.
